(19) United States
(12) Patent Application Publication
(10) Pub. No.: US 2018/0026238 A1
(43) Pub. Date: Jan. 25, 2018

(54) SEALED BATTERIES

(71) Applicant: Sanyo Electric Co., Ltd., Daito-shi, Osaka (JP)

(72) Inventors: Kazushi Andou, Osaka (JP); Shuichi Yamashita, Tokushima (JP)

(73) Assignee: Sanyo Electric Co., Ltd., Daito-shi, Osaka (JP)

(21) Appl. No.: 15/547,921

(22) PCT Filed: Feb. 26, 2016
(86) PCT No.: PCT/JP2016/001046

§ 371 Date: Aug. 1, 2017

(30) Foreign Application Priority Data
Mar. 6, 2015 (JP) 2015-044186

(51) Int. Cl. H01M 2/08; H01M 2/30; H01M 2/34; H01M 2/04

(52) U.S. Cl. CPC H01M 2/08; H01M 2/04; H01M 2/30; H01M 2/34

(57) ABSTRACT

A sealed battery of the invention includes a bottomed cylindrical housing accommodating an electrode assembly and an electrolytic solution, and a sealing unit fixed by crimping of an open end of the housing, the sealing unit including at least a valve body, a terminal plate welded to a central portion of the valve body so as to be farther inside the battery than the valve body, and an annular insulating member disposed between outer peripheral portions of the valve body and of the terminal plate, the terminal plate having a welded portion formed as a fusion mark during welding with the valve body, the terminal plate having a thin portion disposed around the welded portion, the distance from the outermost edge of the welded portion to the thinnest part of the thin portion being not more than 1 mm.

### TECHNICAL FIELD

The present invention relates to sealed batteries which include a sealing unit having a current interrupt device.

### BACKGROUND ART

Nonaqueous electrolyte secondary batteries, which are a type of sealed batteries, have a high energy density and are widely used as power supplies for driving mobile electronic equipment such as smartphones, tablet computers, laptops and mobile music players. The range of applications of nonaqueous electrolyte secondary batteries has recently widened to electric tools, power-assisted bicycles, electric vehicles and the like, which has led to a demand for high safety even when the nonaqueous electrolyte secondary batteries are used under severe conditions.

Because of the use of flammable organic solvents in electrolytic solutions, nonaqueous electrolyte secondary batteries incorporate a mechanism that ensures safety in case of internal short circuits or overcharging due to external impact, misuse or any other causes.

For example, Patent Literatures 1 to 3 disclose that an explosion-proof valve or a current interrupt device is incorporated into a sealing unit in order to ensure the safety of a sealed battery. The explosion-proof valve is composed of a valve body including a highly flexible metal foil. The valve body is deformed as the pressure inside the battery increases. When the internal pressure of the battery reaches a prescribed value, the valve body ruptures to release the gas from the inside of the battery. The current interrupt device is configured to break part of a current path when the pressure inside the battery reaches a prescribed value. The interruption of a current path makes use of an action of a valve body deforming toward the outside of the battery. In Patent Literatures 1 to 3, a lead extending from an electrode assembly is welded to a terminal plate, and the terminal plate is welded to a valve body. The terminal plate has a thin portion which is a weakened portion disposed around the portion of the terminal plate welded to the valve body. When the internal pressure of the battery rises, the valve body pulls the portion of the terminal plate welded thereto toward the outside of the battery and, at a prescribed internal pressure of the battery, the thin portion ruptures. In this manner, the current path between the valve body and the terminal plate is interrupted. An annular insulating member is disposed between the valve body and the terminal plate to ensure insulation therebetween after the rupture of the thin portion.

### CITATION LIST

### Patent Literature

PTL 1: Japanese Published Unexamined Patent Application No. 10-64499

PTL 2: Japanese Published Unexamined Patent Application No. 10-302744

PTL 3: Japanese Published Unexamined Patent Application No. 2009-110808

### SUMMARY OF INVENTION

### Technical Problem

The pressure which actuates a current interrupt device may be controlled by changing the thickness of a thin portion formed in a terminal plate. However, the actuation pressure has a certain range of variation. Thus, the actuation pressure is set slightly low in consideration of such a variation. The reduction in the variation of actuation pressure allows the actuation pressure to be set high and the mechanical strength of the terminal plate to be enhanced, thus contributing to an improvement in yield in battery manufacturing steps. Further, a sealed battery having a higher capacity generates more gas within the battery. Thus, a sealed battery designed with a high capacity requires a current interrupt device which is actuated stably at a high actuation pressure.

As described in Patent Literatures 1 to 3, the conventional technique is such that a valve body and a terminal plate are welded together at their central points, and a thin portion is disposed remote from the weld. Such a configuration seems to protect the thin portion from the influence of welding and to eliminate a factor that can give rise to a variation in actuation pressure. However, studies by the present inventors have revealed that such remoteness of a thin portion from a welded portion is one of the causes of a variation in actuation pressure.

The present invention has been made in light of the circumstances discussed above. It is therefore an object of the invention to provide a sealed battery which includes a current interrupt device actuatable with a reduced variation in actuation pressure.

### Solution to Problem

To achieve the above object, an aspect of the present invention resides in a sealed battery including a bottomed cylindrical housing accommodating an electrode assembly and an electrolytic solution, and a sealing unit fixed by crimping of an open end of the housing, the sealing unit including at least a valve body, a terminal plate welded to a central portion of the valve body so as to be farther inside the battery than the valve body, and an annular insulating member disposed between outer peripheral portions of the valve body and of the terminal plate, the terminal plate having a welded portion formed as a fusion mark during welding with the valve body, the terminal plate having a thin portion disposed around the welded portion, the distance from the outermost edge of the welded portion to the thinnest part of the thin portion being not more than 1 mm.

### Advantageous Effects of Invention

According to one aspect of the present invention, the variation in the actuation pressure of a current interrupt device is reduced and the safety of sealed batteries can be enhanced.

### BRIEF DESCRIPTION OF DRAWINGS

FIG. 1 is a sectional perspective view of a cylindrical nonaqueous electrolyte secondary battery according to an embodiment of the present invention.

FIG. 2 is a sectional view of a sealing unit according to an embodiment of the present invention.

FIG. 3 is an enlarged view of region A illustrated in FIG. 2.

FIG. 4 is a plan view of a sealing unit according to an embodiment of the present invention, viewed from the inside of a battery.

FIG. 5 is a schematic view illustrating an apparatus used for the measurement of actuation pressure.

### DESCRIPTION OF EMBODIMENTS

Hereinbelow, embodiments of the present invention will be described taking, as an example, cylindrical nonaqueous electrolyte secondary batteries which are a type of sealed batteries. The embodiments described below do not limit the scope of the present invention, and may be altered appropriately without departing from the spirit of the invention.

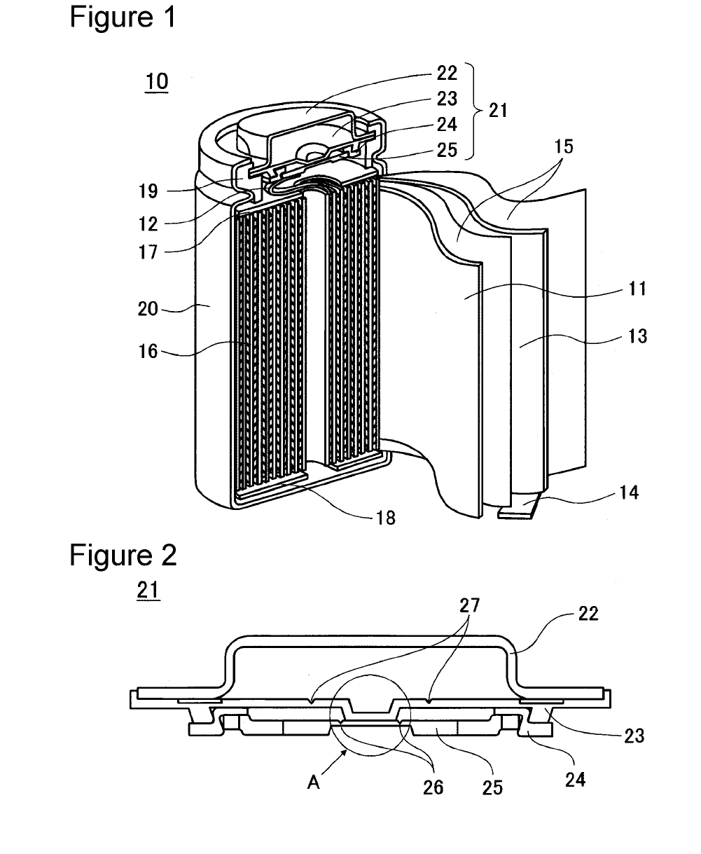

First, a configuration of a cylindrical nonaqueous electrolyte secondary battery 10 representing an embodiment of the present invention will be described with reference to FIG. 1. A bottomed cylindrical housing 20 accommodates an electrode assembly 16, and an open end of the housing 20 is crimped to fix a sealing unit 21 via a gasket 19, thereby sealing the inside of the nonaqueous electrolyte secondary battery 10. The housing 20 also accommodates a nonaqueous electrolytic solution that is not shown, together with the electrode assembly 16. Most of the nonaqueous electrolytic solution penetrates into the inside of the electrode assembly 16. An upper insulating plate 17 and a lower insulating plate 18 are disposed on and under the electrode assembly 16. The sealing unit 21, the electrode assembly 16 and the nonaqueous electrolytic solution will be described in detail below.

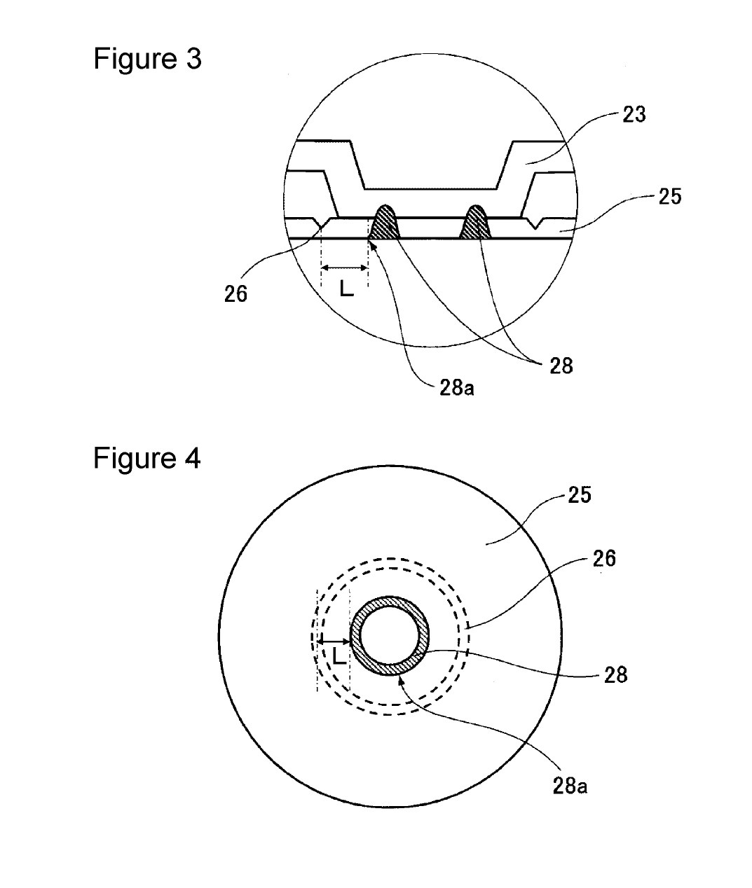

The sealing unit 21 is a stack composed of a terminal cap 22, a valve body 23, an annular insulating member 24 and a terminal plate 25. As illustrated in FIGS. 3 and 4, the valve body 23 and the terminal plate 25 are welded together so that the planar shape of a welded portion 28 is annular. The terminal plate 25 has an annular thin portion 26 formed to enclose the welded portion 28. The valve body 23 also has an annular thin portion 27. The terminal cap 22 is mounted on the valve body 23, and a flange portion of the terminal cap is laser welded to the valve body 23. In this case, welding does not need to be performed on the entire periphery of the flange portion, and it is sufficient to spot-weld at several points.

In the sealing unit 21 having the above configuration, a current interrupt device is actuated in the following manner. A vent hole is disposed in the terminal plate 25 to allow the valve body 23 to experience a rise in the pressure inside the battery. When the pressure inside the battery rises, the terminal plate 25 is pulled by the valve body 23. If the pressure inside the battery reaches a prescribed value, the thin portion 26 of the terminal plate 25 ruptures. Because the respective peripheral portions of the valve body 23 and the terminal plate 25 are insulated from each other by the insulating member 24, the rupture interrupts the current path between the valve body 23 and the terminal plate 25. If the pressure inside the battery continues to rise further, the valve body 23 ruptures starting from the thin portion 27 formed in the valve body 23, releasing the gas within the battery to the outside. In this manner, the valve body 23 serves as an explosion-proof valve. The valve body 23 may be a rapture plate which ruptures when the pressure inside the battery reaches a prescribed value. In this case, the valve body 23 serves as an explosion-proof valve even without the thin portion 27.

Because the valve body 23 is required to deform with an increase in the pressure inside the battery, a highly flexible metal is preferably used. When used in nonaqueous electrolyte secondary batteries, the valve body 23 and the terminal plate 25 are preferably aluminum or aluminum alloy in consideration of corrosion resistance when exposed to positive electrode potentials in the nonaqueous electrolytic solution.

The insulating member 24 may be any of materials which can ensure insulation between the valve body 23 and the terminal plate 25 and do not affect battery characteristics. The material of the insulating member 24 is preferably a polymer resin, with specific examples including polypropylene (PP) resins and polybutylene terephthalate (PBT) resins.

The insulating member 24 has a Z-shaped cross section, and the valve body 23 has an annular projection. This configuration allows the three members, namely, the valve body 23, the terminal plate 25 and the insulating member 24 to be fixed integrally. The insulating member 24 may be a flat insulating plate. In this case, the valve body does not require an annular projection.

A central portion of the valve body 23 projects toward the terminal plate 25. This configuration is adopted to facilitate welding of the valve body 23 to the terminal plate 25. It is preferable that at least one of the valve body 23 and the terminal plate 25 project toward the other.

The valve body 23 and the terminal plate 25 are welded together so that the planar shape of the welded portion 28 will be annular. The welding is preferably laser welding, and the laser is preferably a fiber laser.

When the valve body 23 and the terminal plate 25 are welded by laser welding, it is preferable that the laser beam be applied from the terminal plate 25 side. In this case, a welded portion 28 such as one illustrated in FIG. 3 is formed in the terminal plate 25. The welded portion 28 shown in FIG. 3 is formed as a fusion mark during the welding of the valve body 23 and the terminal plate 25. Although the welded portion 28 is visible to the naked eye, the outermost edge of the welded portion 28 can be identified more clearly by observing an enlarged cross section of the sealing unit 21 with an optical microscope. The sectional shape of the welded portion 28 is not particularly limited but is preferably bilaterally symmetric.

The present invention is characterized in that the distance L from the outermost edge 28a of the welded portion 28 to the thinnest part of the thin portion 26 is not more than 1 mm. While the outermost edge 28a and the thinnest part of the thin portion 26 are located at different positions in the direction of the thickness of the terminal plate 25, the distance L indicates the distance on the plane of the terminal plate 25 as illustrated in FIGS. 3 and 4.

The sectional shape of the thin portion 26, although not particularly limited, may be a V-shape or a U-shape, and is particularly preferably a V-shape. In the case where the thinnest part of the thin portion 26 is in the form of a plane, the distance L is determined based on the point of the thinnest part that is nearest to the outermost edge 28a.

While the thin portion 26 and the welded portion 28 formed in the terminal plate 25 are preferably perfect circles in a plan view, other annular planar shapes such as ellipses are also usable. The thin portion 26 and the welded portion 28 preferably have planar shapes similar to each other, in which case the thin portion 26 and the welded portion 28 are remote from each other by a uniform distance and the advantageous effects of the present invention are produced more effectively. While the planar shapes of the thin portion 26 and the welded portion 28 are preferably annular, the advantageous effects of the invention are attained similarly even when the annular shapes are partly discontinuous C-shapes.

In the present embodiment, the sealing unit 21 includes the terminal cap 22 as a constituent member. The terminal cap 22 may be fabricated from, for example, a plate made of a metal such as iron or stainless steel. Because the terminal cap 22 serves as an external terminal that is connected to an external device or the like, it is preferable that the terminal cap 22 be made of a material having high mechanical strength.

The current interrupt device can be constituted by the valve body, the terminal plate and the insulating member. Thus, the sealing unit of the invention may be composed solely of these three members. Because in this case the valve body will be used as an external terminal, a sealed secondary battery that is provided attains excellent gas release performance in the event of a rupture of the valve body.

As illustrated in FIG. 1, the electrode assembly 16 according to the present embodiment is fabricated by winding a positive electrode plate 11 and a negative electrode plate 13 via a separator 15.

For example, the positive electrode plate 11 may be fabricated as follows. First, a positive electrode active material and a binder are kneaded to uniformity in a dispersion medium to give positive electrode mixture slurry. The binder is preferably polyvinylidene fluoride, and the dispersion medium is preferably N-methylpyrrolidone. A conductive agent such as graphite or carbon black is preferably added to the positive electrode mixture slurry. The positive electrode mixture slurry is applied onto a positive electrode current collector, and the wet film is dried to form a positive electrode mixture layer. During this process, part of the positive electrode current collector is left exposed from the positive electrode mixture layer. The positive electrode mixture layer is then compressed with a roller. A positive electrode plate 11 is thus obtained. Lastly, a positive electrode lead 12 is connected to the exposed portion of the positive electrode current collector.

The positive electrode active material may be a lithium transition metal composite oxide capable of storing and releasing lithium ions. Examples of the lithium transition metal composite oxides include those of the general formulas LiMO₂ (M is at least one of Co, Ni and Mn), LiMn₂O₄ and LiFePO₄. These materials may be used singly, or two or more may be used as a mixture. The material may contain at least one selected from the group consisting of Al, Ti, Mg and Zr, in addition to or in place of the transition metal element.

For example, the negative electrode plate 13 may be fabricated as follows. First, a negative electrode active material and a binder are kneaded to uniformity in a dispersion medium to give negative electrode mixture slurry. The binder is preferably styrene butadiene copolymer or a modified product thereof, and the dispersion medium is preferably water. A thickening agent such as carboxymethylcellulose is preferably added to the negative electrode mixture slurry. The negative electrode mixture slurry is applied onto a negative electrode current collector, and the wet film is dried to form a negative electrode mixture layer. During this process, part of the negative electrode current collector is left exposed from the negative electrode mixture layer. The negative electrode mixture layer is then compressed with a roller. A negative electrode plate 13 is thus obtained. Lastly, a negative electrode lead 14 is connected to the exposed portion of the negative electrode current collector.

The negative electrode active material may be a carbon material capable of storing and releasing lithium ions, or a metal material which can be alloyed with lithium. Examples of the carbon materials include graphites such as natural graphite and artificial graphite. Examples of the metal materials include silicon, tin and oxides of these metals. The carbon materials and the metal materials may be used singly, or two or more may be used as a mixture.

The separator 15 may be a microporous film based on a polyolefin such as polyethylene (PE) or polypropylene (PP). A single microporous film, or a stack of two or more such films may be used. In the case where the separator is a stack including two or more layers, it is preferable that a layer based on polyethylene (PE) having a low melting point be an intermediate layer, and polypropylene (PP) having excellent oxidation resistance be a surface layer. Further, inorganic particles such as aluminum oxide (Al₂O₃), titanium oxide (TiO₂) or silicon oxide (SiO₂) may be added to the separator 15. Such inorganic particles may be suspended within the separator or may be applied together with a binder onto the separator surface.

The nonaqueous electrolytic solution may be a solution of a lithium salt as an electrolyte salt in a nonaqueous solvent.

Some nonaqueous solvents that can be used are cyclic carbonate esters, chain carbonate esters, cyclic carboxylate esters and chain carboxylate esters. Preferably, two or more of these solvents are used as a mixture. Examples of the cyclic carbonate esters include ethylene carbonate (EC), propylene carbonate (PC) and butylene carbonate (BC). The cyclic carbonate esters may be substituted with fluorine in place of part of the hydrogen atoms, with examples including fluoroethylene carbonate (FEC). Example of the chain carbonate esters include dimethyl carbonate (DMC), ethyl methyl carbonate (EMC), diethyl carbonate (DEC) and methyl propyl carbonate (MPC). Examples of the cyclic carboxylate esters include γ-butyrolactone (γ-BL) and γ-valerolactone (γ-VL). Examples of the chain carboxylate esters include methyl pivalate, ethyl pivalate, methyl isobutyrate and methyl propionate.

Examples of the lithium salts include LiPF₆, LiBF₄, LiCF₃SO₃, LiN(CF₃SO₂)₂, LiN(C₂FsSO₂)₂, LiN(CF₃SO₂)(C₄FgSO₂), LiC(CF₃SO₂)₃, LiC(C₂FsSO₂)₃, LiAsF₆, LiClO₄, Li₂B₁₀Cl₁₀ and Li₂B₁₂Cl₁₂. Of these, LiPF₆ is particularly preferable. The concentration in the nonaqueous electrolytic solution is preferably 0.5 to 2.0 mol/L. LiPF₆ may be mixed with other lithium salt such as LiBF₄.

### EXAMPLES

The sealing unit discussed as an embodiment of the present invention with reference to FIGS. 1 and 2 will be described in detail below based on specific examples.

### Example 1

### (Fabrication of Sealing Unit)

A terminal cap 22, a valve body 23 and a terminal plate 25 were fabricated by pressing metal plates. Iron was used for the terminal cap 22, and aluminum for the valve body 23 and the terminal plate 25. By pressing, projections were formed at a central portion and an outer peripheral portion of the valve body 23, and an annular thin portion 27 was formed around the central projection. This thin portion 27 would serve as a starting point of a rupture of the valve body 23 in the event of a further rise in internal battery pressure after the actuation of the current interrupt device. A thin region was formed in a central portion of the terminal plate 25 and, within the region, a thin portion 26 was formed which had an annular planar shape and a V-shaped cross section. Further, a vent hole was formed in the terminal plate 25. The thickness of the thin portion 26 was controlled so that the current interrupt device would be actuated at 2.5 MPa.

An insulating member 24 was fabricated by hot molding a polybutylene terephthalate (PBT) resin plate into a Z shape in cross section.

The outer peripheral projection of the valve body 23 and the outer peripheral end of the terminal plate 25 fabricated as described above were fitted into the insulating member 24 as illustrated in FIG. 2, and thereby the valve body 23, the insulating member 24 and the terminal plate 25 were fixed to one another. During this process, the central projection of the valve body 23 was caused to abut on the central thin region of the terminal plate, and a laser beam was applied from the terminal plate 25 side to weld the valve body 23 and the terminal plate 25 together. The welding was performed so that a welded portion 28 having an annular planar shape as illustrated in FIG. 4 would be formed in the terminal plate 25. As illustrated in FIG. 3, the welded portion 28 was a fusion mark extending through the terminal plate 25 to a depth in the valve body 23. The welding was controlled so that the distance L from the outermost edge 28a of the welded portion 28 to the thinnest part of the thin portion 26 would be 0.5 mm.

Lastly, the terminal cap 22 was placed on the valve body 23, and a laser beam was applied to a flange portion of the terminal cap 22, thereby welding the terminal cap 22 to the valve body 23. A sealing unit 21 of EXAMPLE 1 was thus fabricated.

### Example 2

A sealing unit 21 of EXAMPLE 2 was fabricated in the same manner as in EXAMPLE 1, except that the distance L was changed to 1.0 mm.

### Comparative Example 1

A sealing unit of COMPARATIVE EXAMPLE 1 was fabricated in the same manner as in EXAMPLE 1, except that the distance L was changed to 1.5 mm.

### Comparative Example 2

A sealing unit of COMPARATIVE EXAMPLE 2 was fabricated in the same manner as in EXAMPLE 1, except that the distance L was changed to 2.0 mm.

### (Measurement of Pressure Causing Actuation of Current Interrupt Device)

Thirty sealing units fabricated in each of EXAMPLES 1 and 2 and COMPARATIVE EXAMPLES 1 and 2 were tested to measure actuation pressure. The measurement of actuation pressure was performed as follows.

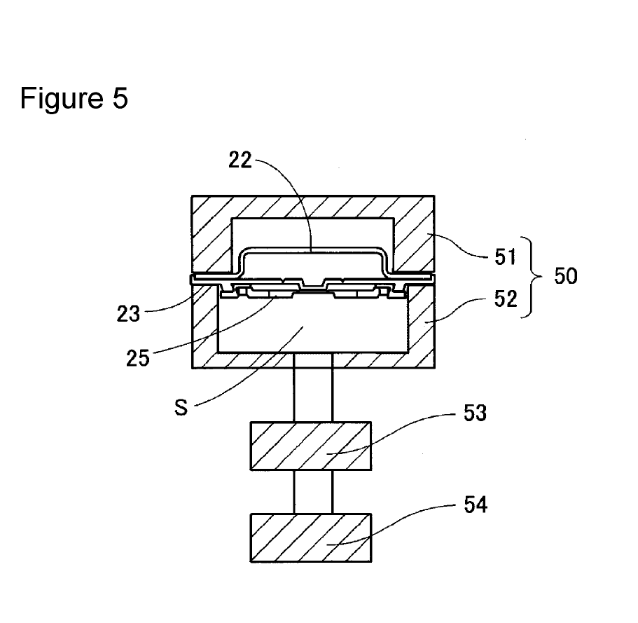

As illustrated in FIG. 5, the sealing unit was fixed to a fixing jig 50 having a pressing section 51 and a supporting section 52. The supporting section 52 is fixed to part of the measurement apparatus, and a pressing force was applied from above the pressing section 51 using an air cylinder so as to ensure the airtightness in the space S enclosed by the valve body 23 and the supporting section 52. Nitrogen gas was supplied to the space S at a constant rate from a nitrogen gas tank 54 via a regulator 53.

During the supply of nitrogen gas, the pressure in the space S and the continuity of the current path between the terminal cap and the terminal plate were checked in real time. The continuity of the current path was examined by connecting a pair of electrode terminals connected to a galvanometer to the pressing section 51 of the fixing jig 50 and the terminal plate. The pressing section 51 was composed of a metal and was thus electrically connected to the terminal cap.

The pressure in the space S at which the current path between the terminal cap and the terminal plate was interrupted during the supply of nitrogen gas was obtained as the actuation pressure of the current interrupt device of the sealing unit. The actuation pressure was measured with respect to thirty sealing units fabricated in each of EXAMPLES 1 and 2 and COMPARATIVE EXAMPLES 1 and 2. Table 1 describes the average value, minimum value, maximum value and variation of actuation pressure in each of EXAMPLES and COMPARATIVE EXAMPLES. The range of variation is a difference determined by subtracting the minimum value of actuation pressure from the maximum value.

TABLE 1

| | | Actuation pressure of current | | | |
|---|---|---|---|---|---|
| | | interrupt device (MPa) | | | |
| | Distance L | Average | Minimum | Maximum | Range of |
| | (mm) | value | value | value | variation |
| EX. 1 | 0.5 | 2.50 | 2.48 | 2.52 | 0.04 |
| EX. 2 | 1.0 | 2.49 | 2.47 | 2.51 | 0.04 |
| COMP. EX. 1 | 1.5 | 2.82 | 2.55 | 3.02 | 0.47 |
| COMP. EX. 2 | 2.0 | 2.88 | 2.53 | 3.12 | 0.59 |

From Table 1, in spite of the fact that the thin portions of the terminal plates in EXAMPLES and COMPARATIVE EXAMPLES all had the same thickness, the actuation pressures in COMPARATIVE EXAMPLES 1 and 2 were greater by more than 0.3 MPa than the actuation pressures in EXAMPLES 1 and 2. The average value of actuation pressure may be decreased by reducing the thickness of the thin portion, but the reduction in thickness results in a decrease in the mechanical strength of the terminal plate. An advantage of the present invention is that the actuation pressure can be controlled without excessive thinning of the thin portion.

The ranges of variation in the actuation pressure of the current interrupt device differed greatly between EXAMPLES and COMPARATIVE EXAMPLES. In particular, the average value and the range of variation of actuation pressure changed significantly when the distance L was 1.0 mm as compared to 1.5 mm. From the results discussed above, the present invention has a very marked effect in reducing the variation of the actuation pressure of a current interrupt device. Thus, according to the present invention, the reliability of a current interrupt device is increased and a sealed battery with excellent safety can be provided.

### INDUSTRIAL APPLICABILITY

As described hereinabove, the present invention can reduce the variation in the actuation pressure of a current interrupt device, making it possible to provide a sealed battery having excellent safety. Thus, the present invention has great applicability in industry.

### REFERENCE SIGNS LIST

10 NONAQUEOUS ELECTROLYTE SECONDARY BATTERY
11 POSITIVE ELECTRODE PLATE
12 POSITIVE ELECTRODE LEAD
13 NEGATIVE ELECTRODE PLATE
14 NEGATIVE ELECTRODE LEAD
15 SEPARATOR
16 ELECTRODE ASSEMBLY
17 UPPER INSULATING PLATE
18 LOWER INSULATING PLATE
19 GASKET
20 HOUSING
21 SEALING UNIT
22 TERMINAL CAP
23 VALVE BODY
24 INSULATING MEMBER
25 TERMINAL PLATE
26, 27 THIN PORTIONS
28 WELDED PORTION
28a OUTERMOST EDGE OF WELDED PORTION

1. A sealed battery comprising:
a bottomed cylindrical housing accommodating an electrode assembly and an electrolytic solution, and
a sealing unit fixed by crimping of an open end of the housing,
the sealing unit including at least a valve body, a terminal plate welded to a central portion of the valve body so as to be farther inside the battery than the valve body, and an annular insulating member disposed between outer peripheral portions of the valve body and of the terminal plate,
the terminal plate having a welded portion formed as a fusion mark during welding with the valve body, the terminal plate having a thin portion disposed around the welded portion,
the distance from the outermost edge of the welded portion to the thinnest part of the thin portion being not more than 1 mm.

2. The sealed battery according to claim 1, wherein the planar shapes of the welded portion and of the thin portion are each either of an annular shape and a C-shape.

3. The sealed battery according to claim 1, wherein the planar shapes of the welded portion and of the thin portion are annular.

4. The sealed battery according to claim 1, wherein the planar shape of the thin portion is similar to the welded portion.

5. The sealed battery according to claim 1, wherein the sectional shape of the thin portion is a V-shape or a U-shape.

6. The sealed battery according to claim 1, wherein the thin portion is disposed on a side, of the terminal plate, that faces the outside of the battery.

7. The sealed battery according to claim 1, wherein the sealing unit has a terminal cap as an outermost member.
